(19) United States
(12) Patent Application Publication
(10) Pub. No.: US 2008/0012749 A1
(43) Pub. Date: Jan. 17, 2008

(54) STANDOFF RADIATION DETECTION SYSTEM

(75) Inventor: David L. FRANK, Boca Raton, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Innovative American Technology, Inc., Boca Raton, FL (US)

(21) Appl. No.: 11/623,608

(22) Filed: Jan. 16, 2007

Related U.S. Application Data
(60) Provisional application No. 60/831,284, filed on Jul. 17, 2006.

(51) Int. Cl. G01S 13/00; G01S 7/40

(52) U.S. Cl. 342/27; 342/59; 342/192; 342/90; 342/58

(57) ABSTRACT

A standoff radiation detection and identification system is capable of detecting radiation from remote locations, such as at distances of 100 feet or more. The system can verify radiation associated with vehicles or vessels prior to them entering sensitive areas. The ability to detect radiation at standoff distances enables the interception of the vehicle or vessel for further analysis. The system combines standoff radiation detection with interceptors that can be deployed for further close range analysis of a source of radiation.

### CROSS-REFERENCE TO RELATED APPLICATIONS

This application is based on, and claims priority from prior co-pending U.S. Provisional Patent Application No. 60/831,284 filed on Jul. 17, 2006, the entire teachings thereof being hereby incorporated by reference.

### FIELD OF THE INVENTION

This invention relates in general to radiation detection systems, and more particularly to a radiation detection and identification system to remotely detect and identify radiological materials by use of radar and spectral analysis.

### DESCRIPTION OF RELATED ART

Current attempts at providing radiation detection and identification are limited to very short distances where the detectors must be in close proximity to the radiological material or source of radiation. Without a standoff radiation detection system capable of remotely detecting radiation, such as from distances of 100 feet or more, oncoming vehicles or vessels can not be verified prior to entering sensitive areas. Without the ability to detect radiation at standoff distances vessels and vehicles carrying radiation may not be effectively targeted for further analysis prior to entering these sensitive areas.

Therefore a need exists to overcome the problems with the prior art as discussed above.

### SUMMARY OF THE INVENTION

The present invention provides a standoff radiation detection system capable of remotely detecting radiation, such as from distances of 100 feet or more, through the use of radar and spectral analysis. This provides a new ability to verify oncoming vehicles or vessels prior to entering sensitive areas. The ability to detect radiation at standoff distances enables the interception of the vehicle or vessel for further analysis. One alternative embodiment of the invention also provides for a mobile interceptor unit that can be deployed for close analysis of the radiological materials detected by the standoff radiation detection system.

The standoff radiation detection system and method, according to one embodiment, uses radar systems and/or focused detectors, for analysis of radiation leaking from an oncoming vehicle, container or vessel. The spectral data acquired from the radar and/or focal view detector system allows pattern recognition software to detect and identify radiological materials. This standoff detection system enables detection of radiological materials at distances of 100 feet or more and allows for the interception of the oncoming vehicle or vessel.

As an additional measure, Gamma and Neutron collimators and focusing lenses may also be deployed to increase the detection ranges of conventional radiation detectors.

A millimeter-wave (mmW) radar detection system a well known technology and can be coupled with specialized software to locate radioactive substances with impressive speed and accuracy from long distances. The detection of radiation is based on measuring changes in scattering properties of the leak or radiation plume with a pulsed radar system. A network of mmW radar detection systems can be deployed and monitored using computer-based information management systems that record and respond to information as it is received.

The millimeter waves (MMW) are defined from 30 GHz to 300 GHz. Millimeter wave radars (MMWR) have smaller components and greater bandwidths than microwave radars. They have high speed and high resolution and less attenuation than microwave radars. Basic types of MMWR are continuous wave radar (CWR), frequency modulated continuous wave radar (FMCWR), and pulsed-wave radar (PWR). For our applications we will utilize the pulsed-wave millimeter wave radar.

The radar system identifies radiation through the affects that the radiation has on surrounding air or materials. For example, a radiation plume would be detected by millimeter a wave radar system by identifying the affects of the radiological materials on the surrounding air. Another example would be the identification of radiological affects on the hull of a ship or the metal surfaces of a container.

A vehicle or vessel, such as a truck, automobile, train, subway, airplane, aircraft, ship, or boat, can be remotely monitored by a standoff radiation detection and identification system, according to an embodiment of the present invention.

An interceptor, such as a truck, automobile, aircraft, or boat, can be dispatched to more closer analyze a radiation source remotely detected by the standoff radiation detection system.

For applications such as shipping ports a radar system could be deployed to verify vessels before they reach the port. Interceptor boats, for example, can be dispatched with radiation detection and identification systems for further analysis. The radar and or focal view systems could be mounted on fixed positions on land or on boats patrolling the area.

### BRIEF DESCRIPTION OF THE DRAWINGS

FIG. 1 is a simplified block diagram illustrating an example of a standoff radiation detection and identification system, including data collection and analysis system.

FIG. 2 is a geographical view illustrating an example use of a standoff radiation detection and identification system, including a radar system, for remote detection of radiation associated with suspect vessels near a port.

FIG. 3 is a simplified schematic illustrating an example of an interceptor vessel.

FIG. 4 is a simplified schematic illustrating an example of an interceptor system.

FIG. 5 is an illustration of an example of a Standoff Detector.

FIG. 6 is a graph illustrating an example of performance for a 40 cm³ germanium detector.

FIG. 7 is a graph illustrating an example of background radiation.

FIG. 8 is a graph illustrating signal counts as a function of range for various sources.

FIG. 9 is a simplified schematic illustrating an example of a radiation detector with a focal view.

### DETAILED DESCRIPTION

The present invention, according to an embodiment, overcomes problems with the with the prior art by providing an ability to detect and identify radiological materials before they enter a port, metropolitan area or any other sensitive area by using a radar based standoff detection system and the ability to deploy interceptors for further analysis.

The radar based standoff detection system provides data collection and preparation for spectral analysis for detection and identification of the radiological materials. The spectral data is prepared for the analysis software. A database of known radiation materials is maintained to enable the pattern recognition system to identify the known radiological materials.

Described now is an exemplary standoff radiation detection system.

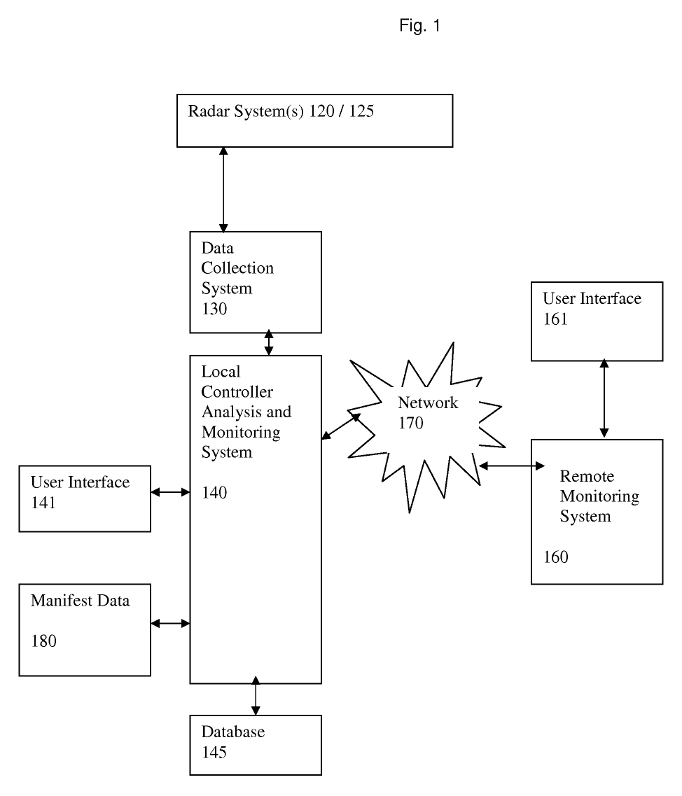

An exemplary standoff radiation detection system as illustrated in FIG. 1, provides significantly improved capabilities for standoff detection of radiological materials.

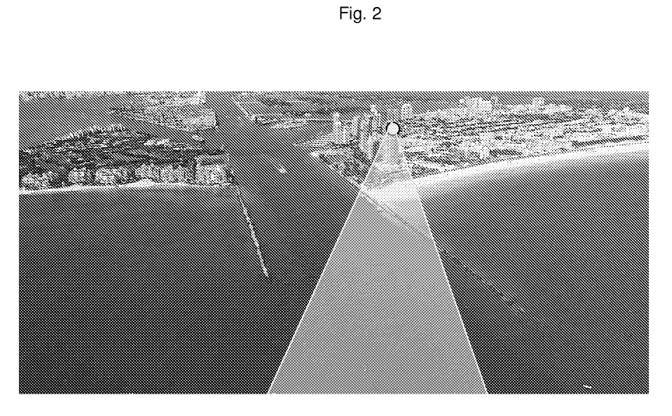

In the exemplary embodiment shown in FIG. 1, a radar system (120) transmits pulsed energy and collects the returning energies via a receiver (125). See FIG. 2 for an example of a long range marine radiation verification system based on radar technologies. Such long-range radiation detection through the use of radar technologies can be used for verification of vessels approaching sensitive areas, such as national borders, at shores or ports.

A data collection system (130), in this example, is communicatively coupled via cabling or other communication link (135) with the radar unit 120. The data collection system 130 includes an information processing system with data communication interfaces that collect signals from the radar unit 120. The collected signals represent detailed spectral data from the radar unit 120.

The data collection system (130) is communicatively coupled with a local processor system (140) and database (145). The local system comprises an information processing system that has a computer, memory, storage, and a user interface such a display on a monitor and a keyboard, or other user input/output device. One of the functions performed by the computer processor is the spectral analysis to detect radiation and identify the isotopes. The user interface allows service or supervisory personnel to operate the system and to monitor the status of radiation detection and identification of isotopes.

The data collection system can also be communicatively coupled with a remote control and monitoring system (160) such as via a network (170). The remote system (170) comprises an information processing system that has a computer, memory, storage, and a user interface such a display on a monitor and a keyboard, or other user input/output device. The network (170) comprises any number of local area networks and/or wide area networks. It can include wired and/or wireless communication networks. This network communication technology is well known in the art. The remote system includes a user interface that allows remotely located service or supervisory personnel to operate the system and to monitor the status of vehicles or vessels under evaluation. By operating the system remotely, such as from a central monitoring location, a larger number of sites can be safely monitored by a limited number of supervisory personnel. The sensor units may be deployed in a wide variety of configurations and positions interconnected via wireless or wire-line communications.

The exemplary embodiment of the present invention, as shown in FIGS. 1 and 2, can be realized in hardware, software, or a combination of hardware and software. A system according to a preferred embodiment of the present

invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

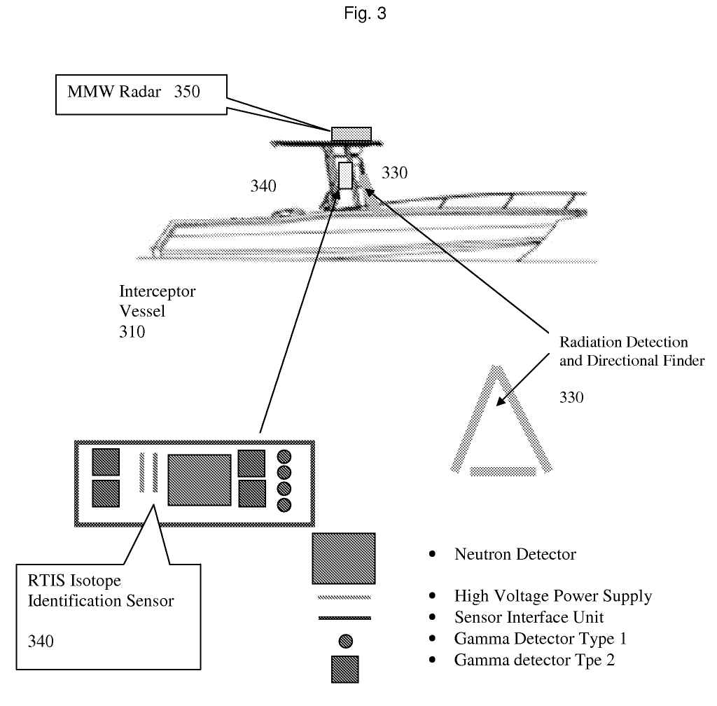

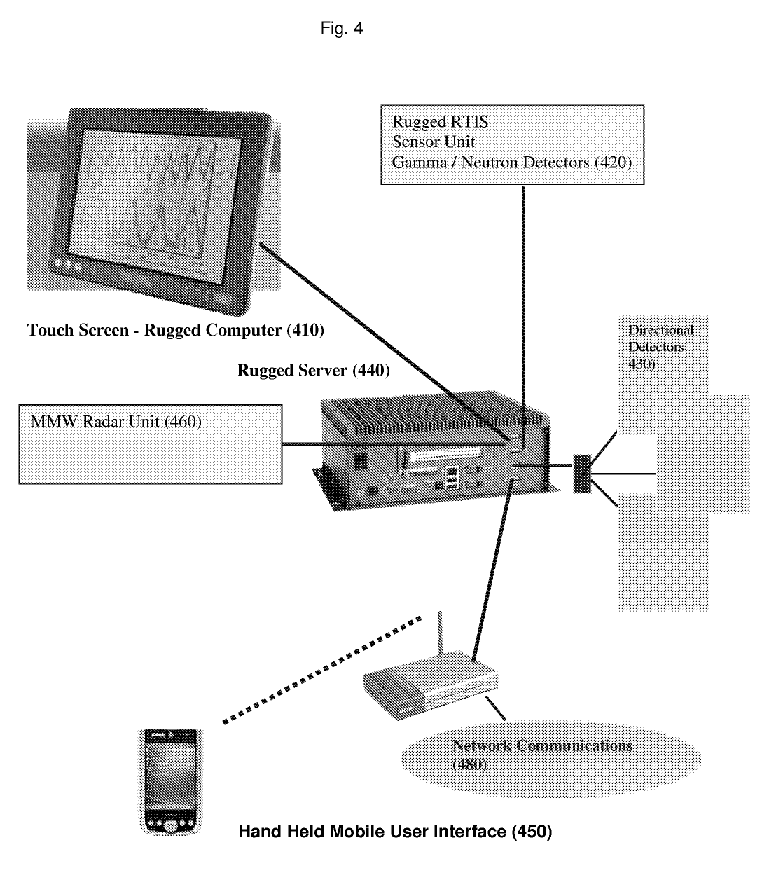

Described now is an exemplary interceptor system, as illustrated in FIGS. 3 and 4. An example of an interceptor vessel is shown in FIG. 3. A mobile marine radiation sensor system is deployed on board of an interceptor vessel to intercept suspect vessels that have been identified as carrying radiological material. The interceptor vessel provides spectral analysis of the detected radiation and allows for the identification of the specific isotopes present associated with the suspect vessel. This data can be used to determine if the radiation is due to normally occurring radiological materials on-board of the suspect vessel or if the radiation represents a threat.

The interceptor vehicle or vessel (310), in this example, is equipped with radiation sensors (330) and millimeter wave (mmw) radar systems (350) to detect and identify positions of radiation and to identify the isotopes(s) present. While millimeter wave radar technology is being used for the present example, other types of radar technology would similarly apply in alternative embodiments of the invention. These sensor systems may use on or more types of radiation detectors. In the example design, a combination of cadmium zinc telluride detectors, sodium iodide detectors and solid-state neutron detectors are used to detect radiation. This provides for good resolution of radiation energies from 10 kev to 3 Mev. The solid-state neutron detectors offer a shock resistant 30 configuration suitable for verifying radiation from vehicles or vessels that can move and cause shock and vibration hazards to the radiation detection system components mounted on the moving vehicle or vessel.

To assist in the detection of radiation at distances, the gamma detectors may be equipped with collimators and/or lenses that gather the radiological particles and focus these particles onto the detectors.

The interceptor system, as illustrated in FIG. 4, can provide a key entry system (410 and 450), a processor (440) and multiple radiation detector systems (420). One of the radiation detector systems may provide an indication of the direction (430) of the source of the radiation for the interceptor.

The interceptor vehicle or vessel (310), in this example, is equipped with radiation sensors (330) and a millimeter wave (mmw) radar system unit (460) to detect and identify positions of radiation and to identify the isotopes(s) present. While millimeter wave radar technology is being used for the present example, other types of radar technology would similarly apply in alternative embodiments of the invention.

The interceptor system can provide spectral data, data collection and perform an analysis to determine if radiological materials are present and determine the isotopes present.

The interceptor can transmit (480) this information to a central monitoring facility to provide on-site analysis data for appropriate actions.

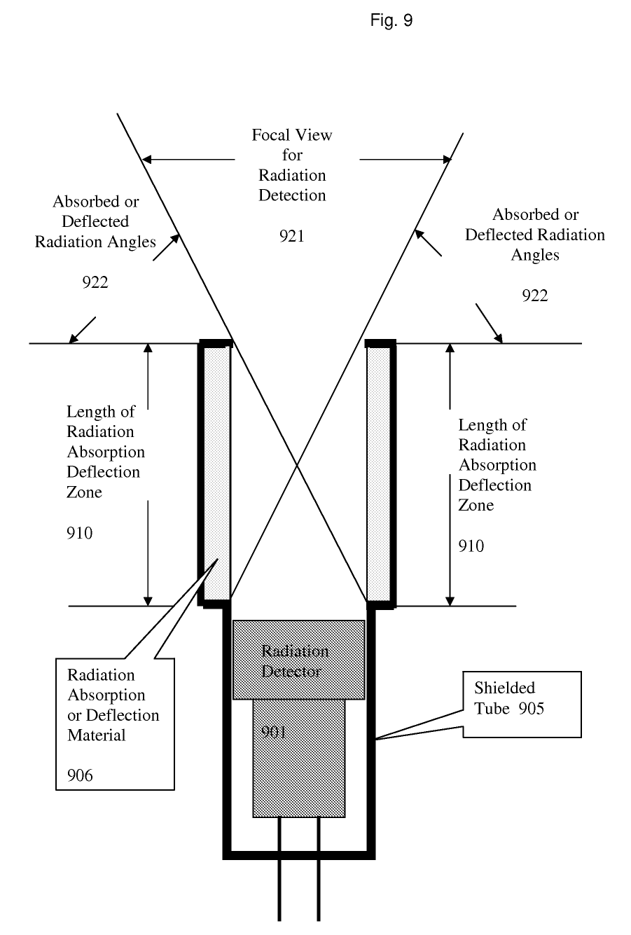

In another embodiment of the invention, as illustrated in FIG. 9, a radiation detector (901) is mounted into a shielded tube (905) to restrict the angle of incidence of the gamma or neutron particles to be detected creating a specific focal view (921) of the detector as illustrated in FIG. 9. The shielded tube restricts background radiation from entering the detector and creates a high signal to noise ratio for radiation detection in the specific direction of the focal view (921). For gamma or neutron emissions that enter the tube on an angle outside of the desired angle of view (922), the particles are absorbed or deflected away from the detector by an absorption/deflection zone (906) inside of the shielded tube (905). The end result is a gamma or neutron count of particles coming from objects within the focal view (921) with minimal background noise.

This high ratio of signal to noise allows for standoff radiation detection at remote distances, such as up to 100 feet and more. The spectral data captured over time allows for spectral analysis and isotope identification.

The focal view (921) can be configured based on the diameter of the shielded tube and the length of the absorption/deflection zone.

These devices could be configured as an array of standoff detectors to cover a larger area and/or speed the data acquisition process.

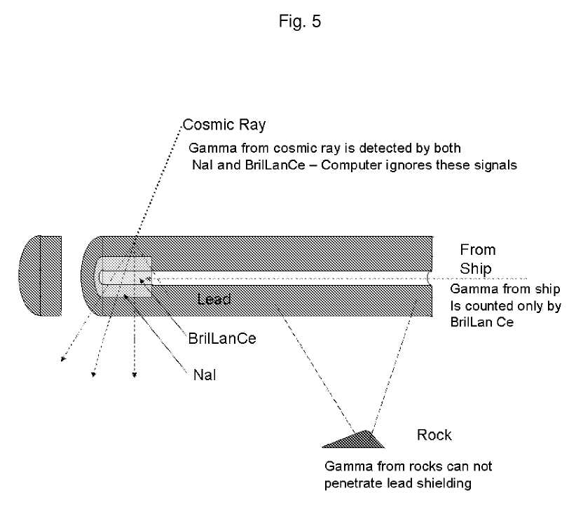

Another embodiment of the shielded tub is described in FIG. 5. This includes the constructing a directional long range gamma ray detector for the purposes of detecting illicit radioactive cargos at sea. This design can also be used for long range neutron detection by exchanging the gamma detector unit for a neutron detector unit. FIG. 5 shows the general configuration of the detector. The device is constructed from two radiation gamma counters. A inner crystal composed of BrilLanCe and a coaxially arranged crystal of Nal. The entire set of crystals is surrounded by a lead pipe fabricated from low activity lead at least 10 cm wall thickness. The end is also capped with a lead.

### BACKGROUND

The device responds to three types of radiation differently.

### 1) Cosmic Rays

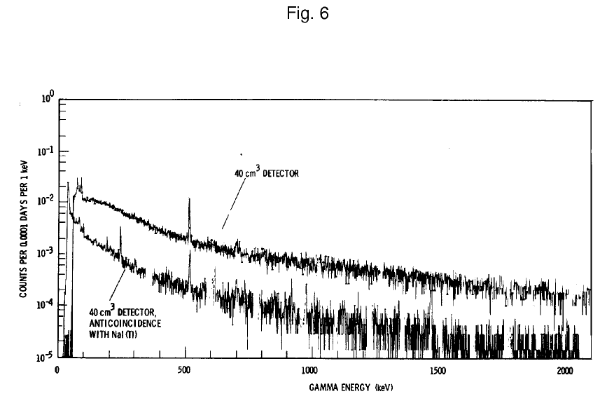

Cosmic rays are normally very high energy and therefore very penetrating. In most cases the cosmic rays will pass right through the lead and be detected by both the Nal and the BrilLanCe detectors. In this case the computer is programmed to reject counts from the BriLanCe detector when ever it sees a count at the same time from the Nal detector. In this way the Cosmic Ray background can be greatly reduced. The figure below shows that the by using anti-coincident counting the background can be reduced by a factor of 10 or more. The figure is for a 40 cm³ germanium detector. We assume a similar level of performance in the proposed system. as described in FIG. 6.

### 2.) Rock

In the case of a gamma coming from the ground the detector has a different response than it had for cosmic rays. In general the gammas from the earth are lower energy than the cosmic ray. Thus these background gammas are stopped by the 10 cm thick lead shield weighing 300 Kg. These gammas are not detected by either detector.

### 3.) Ship

I signal gamma coming from the ship passes un-attenuated directly into the BrilLanCe detector and is counted.

The performance of such a system can be modeled. The background is assumed to be composed of cosmic rays, earth generated gammas as shown in table.

| | | | With shield & |
|---|---|---|---|
| | | Inside 10 cm | anti-coincident |
| | Outside Shield | Lead | counting |
| Cosmic Ray | 12,003 counts/min | 7,201 counts/min | 72 counts/min |
| background | | | |
| Earth | 12,000 counts/min | 1,200 counts/min | 1200 counts/min |
| background | | | |
| Total | 24,003 counts/min | 8,401 counts/min | 1272 counts/min |

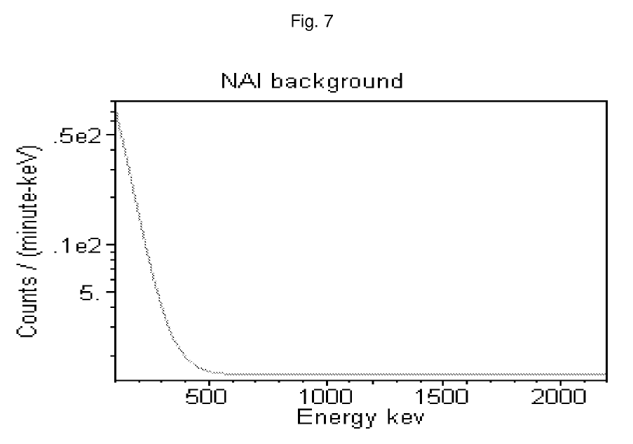

### The background spectra assumed as shown in the FIG. 7.

### Signal

If we consider the source to be 661 kev gamma rays from Cs¹³⁷. The signal strength is given according to the following formula.

$$S = 15 Act * Ad \frac{{e}^{- μρ R}}{π {R}^{2}}$$

where R is the range in cm from source to detector, Act is the source activity as disintegrations/sec, Ad is the detector area facing the source, μ=0.095 for air, and ρ=0.0012 g/cm³ the air density.

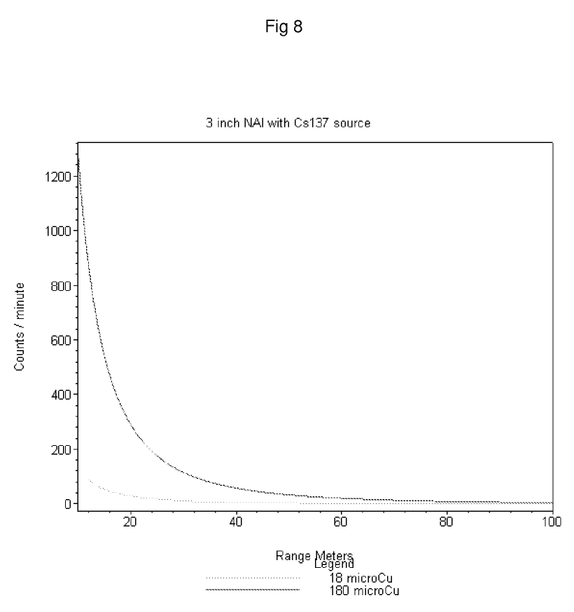

By using this formula the signal counts can be calculated as a function of range for various sources as shown in FIG. 8.

Using the source and the background as specified above, assuming a counting channel width of 3 kev and assuming a minimum Signal-to-Noise-Ratio of three, the effective detection range can be calculated as shown in the table below.

| | 18 μCu | 180 μCu |
|---|---|---|
| Outside Shield | 27.9 meters | 69.8 meters |
| Inside Shield | 43.3 meters | 99.8 meters |
| With shield & anti- | 87.1 meters | 171.5 meters |
| coincident counting | | |

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A standoff radiation detection and identification system for the protection of critical assets comprising:
one or more fixed or movable radar systems;
an object range and position identification processor;
a digital data collection system and communications system for transfer of collected radar data to an analysis system;
a spectral analysis system, coupled to the digital data collection system, to analyze the collected radar data for the presence of radiation and to identify specific isotopes present corresponding to the collected radar data; and
a database of known radiation spectra, coupled with the spectral analysis system, for comparison of spectral data acquired from the one or more radar systems and for identification of the specific isotopes present.

2. The standoff radiation detection and identification system of claim 1, further comprising a central operations center for monitoring the identification of the specific isotopes present with the spectral analysis system, and in response thereto for activation of response protocols.

3. The standoff radiation detection and identification system of claim 1, further comprising one or more interceptor vehicles, including at least one of an automobile and a truck, equipped with radiation sensor systems for the detection of radiation and identification of isotope(s) present at an area of interest, the one or more interceptor vehicles for dispatch in response to the identification of the specific isotopes present with the spectral analysis system.

4. The standoff radiation detection and identification system of claim 3, wherein the one or more interceptor vehicles include:
a radiation directional finder to assist in identifying a source of the radiation; and
an object range and position identification processor.

5. The standoff radiation detection and identification system of claim 1, further comprising one or more interceptor vessels, including at least one of a boat, ship, and aircraft, equipped with radiation sensor systems for the detection of radiation and identification of isotope(s) present at an area of interest, the one or more interceptor vessels for dispatch in response to the identification of the specific isotopes present with the spectral analysis system.

6. The standoff radiation detection and identification system of claim 5, further comprising a GPS system coupled with the one or more interceptor vessels for assisting the one or more interceptor vessels to identify a specific target that is suspected of carrying radiation and to specify a position of the target.

7. The standoff radiation detection and identification system of claim 5, wherein the one or more interceptor vessels including a radiation directional finder to assist in identifying a source of the radiation.

8. A method for using the standoff radiation detection and identification system described in claim 1, comprising:
protecting a metropolitan area by using radiation surveillance of road, highways, waterways, and railways, that lead into the metropolitan area to remotely detect radiation emissions from a vehicle or vessel at a distance of approximately 100 feet or more.

9. A method for using the standoff radiation detection and identification system described in claim 1, comprising:
protecting one or more ports by using radiation surveillance of offshore waters, bays, rivers, water channels, and port entrances to port area.

10. A method for using the standoff radiation detection and identification system described in claim 1, comprising:
monitoring the identification of the specific isotopes present with the spectral analysis system about railways for identifying trains or subways that may be carrying radiation.

11. A method for using the standoff radiation detection and identification system described in claim 1, comprising:
protecting one or more borders of a territorial jurisdiction.

12. A standoff radiation detection and identification system for the protection of critical assets comprising:
one or more fixed or movable gamma detectors encased in a shielded tube to provide an optimum collection of gamma particles within an identified focal range, and which reduce surrounding background noise by:
a. the shielded tube restricting gamma particle entry to the tube opening opposite the gamma detector; and
b. the shielded tube providing for gamma absorption or deflection of those particles that enter the shielded tube, where the particles's angle of incidence being outside of the focal range;
a digital data collection system and communications system for transfer of collected radar data to an analysis system;
a spectral analysis system to analyze the collected radar data for the presence of radiation and to identify specific isotopes present corresponding to the collected radar data; and
a database of known radiation spectra for comparison of the spectral data acquired from the radar system and for identification of the isotopes present.

13. The standoff radiation detection and identification system of claim 12, further comprising one or more interceptor vehicles, including at least one of an automobile and a truck, equipped with radiation sensor systems for the detection of radiation and identification of isotope(s) present at an area of interest, the one or more interceptor vehicles for dispatch in response to the identification of the specific isotopes present with the spectral analysis system.

14. The standoff radiation detection and identification system of claim 13, wherein the one or more interceptor vehicles including a radiation directional finder to assist in identifying a source of the radiation.

15. The standoff radiation detection and identification system of claim 12, further comprising one or more interceptor vessels, including at least one of a boat, ship, and aircraft, equipped with radiation sensor systems for the detection of radiation and identification of isotope(s) present at an area of interest, the one or more interceptor vessels for dispatch in response to the identification of the specific isotopes present with the spectral analysis system.

16. The standoff radiation detection and identification system of claim 15, further comprising a GPS system coupled with the one or more interceptor vessels for assisting the one or more interceptor vessels to identify a specific target that is suspected of carrying radiation and to specify a position of the target.

17. The standoff radiation detection and identification system of claim 15, wherein the one or more interceptor vessels including a radiation directional finder to assist in identifying a source of the radiation.

18. A method for using the standoff radiation detection and identification system described in claim 12, comprising:
protecting one or more ports by using radiation surveillance of offshore waters, bays, rivers, water channels, and port entrances to port area.

19. A method for using the standoff radiation detection and identification system described in claim 12, comprising:
monitoring the identification of the specific isotopes present with the spectral analysis system about railways for identifying trains or subways that may be carrying radiation.

20. A method for using the standoff radiation detection and identification system described in claim 12, further comprising:
adjusting a focal view or range for radiation detection of the one or more fixed or movable gamma detectors based on a length of the shielded tube, a deflection of the radiation, and a length of an absorption zone within the shielded tube.
